(19) United States
(12) Patent Application Publication
(10) Pub. No.: US 2026/0369649 A1
(43) Pub. Date: Nov. 19, 2026

(54) IMPROVED METHOD FOR PRODUCING CELL STACKS BY MEANS OF UNIFORM THERMAL ACTIVATION OF AN ADHESIVE

(71) Applicant: Cellforce Group GmbH, Kirchentellinsfurt (DE)

(72) Inventor: Markus Gräf, Tübingen (DE)

(21) Appl. No.: 19/137,483

(22) PCT Filed: Dec. 5, 2023
(86) PCT No.: PCT/EP2023/084294

§ 371 Date: Jun. 10, 2025

(30) Foreign Application Priority Data
Dec. 12, 2022 (EP) 22212861.3

(51) Int. Cl. H01M 10/04

(52) U.S. Cl. CPC H01M 10/0404

(57) ABSTRACT

A method for producing a cell stack, in particular for an electrochemical storage device, wherein at least anode electrodes, separator layers and cathode electrodes are repeatedly stacked or folded or wound on top of one another, wherein at least one layer is coated on one side or both sides with a thermally activatable adhesive or is provided with the adhesive, wherein electrically conductive layers, in particular the anode electrodes and/or the cathode electrodes, are heated electromagnetically and/or electrically, wherein the adhesive is thermally activated by the heating of the electrically conductive layers and, in particular, the anode electrodes, separator layers and cathode electrodes are joined together to form a cell stack. The invention also relates to a device for producing cell stacks and an electrochemical storage device with at least one cell stack.

### BACKGROUND OF THE INVENTION

The invention relates to a method for producing a cell stack, in particular for an electrochemical storage device, wherein at least anode electrodes, separator layers and cathode electrodes are repeatedly stacked or folded or wound on top of one another. Furthermore, the invention relates to a device for producing cell stacks and an electrochemical storage device with at least one cell stack.

In the production of electrochemical storage devices, such as lithium-ion batteries, several alternating layers of anodes, cathodes and separators are usually arranged in the form of cell stacks. These layers are coated with a thermally activatable adhesive and are then bonded together using heat and force. For this purpose, the layers are positioned between two heating plates, which act on the plurality of layers.

However, heating the layers of the cell stack via the heating plates results in an inhomogeneous temperature distribution along the height or thickness of the cell stack. The uniform bonding between the layers of the cell stack and also the bonding of all layers of the cell stack with the aid of the thermally activatable adhesive cannot be guaranteed due to the inhomogeneous temperature distribution. In addition, the complete heating of all layers of the cell stack is delayed by the electrically and thermally insulating properties of the separator layers, which limits the output of a system in the production of cell stacks.

Methods are already known that press the layers of the cell stack together with greater force during heating or apply a higher temperature to the layers in order to accelerate the bonding process. However, such measures can have a detrimental effect on the material properties of the cell components or the respective layers of the cell stack.

### SUMMARY OF THE INVENTION

According to one aspect of the invention, a method for manufacturing a cell stack is provided. In particular, the cell stack is provided for an electrochemical storage device, such as a lithium-ion cell. Such a cell stack comprises a plurality of anode electrodes, separator layers and cathode electrodes, which are repeatedly stacked or folded or wound on top of each other. In addition, further layers containing graphite or other materials, for example, can be provided.

An anode electrode can, for example, consist of a copper foil or a copper carrier foil, which is coated on one or both sides with an anode substrate. Similarly, a cathode electrode can, for example, consist of an aluminum foil or an aluminum carrier foil, which is coated on one or both sides with a cathode substrate.

For the sake of simplicity, the additional possible layers that are common in the field of lithium-ion batteries are not described further. To form an integral or one-piece cell stack, adhesive layers are used or certain layers are provided with an adhesive in advance. For example, the separator layers are coated on one or both sides with a thermally activatable adhesive or provided with the adhesive.

After the arranged anode electrodes, separator layers and cathode electrodes have been provided, electrically conductive layers, in particular the copper foils and aluminum foils of the anode electrodes and/or the cathode electrodes and/or additional layers or grids, are heated electromagnetically and/or electrically. In contrast to the prior art, in which a heat source is pressed against the cell stack from the outside and the heat slowly spreads from the outside to the inside, heat is now generated directly in all electrically conductive layers of the cell stack. Time-consuming and uneven heat conduction can be eliminated by this measure. By heating the anode electrodes and/or the cathode electrodes, the adhesive of the respective separator layers is thermally activated directly or immediately. By thermally activating the adhesive, the anode electrodes, separator layers and cathode electrodes are bonded together to form a one-piece cell stack. This completes an exemplary cell stack.

Depending on the design of the method and the requirements, additional processing steps, such as electrical connection of contact lugs, adjustment of the final dimensions, application of coatings or packaging, arrangement of positioning aids and the like, can follow or be implemented as part of the method.

According to a further aspect of the invention, a device for producing cell stacks is provided. The device is adapted to carry out the method according to the invention. For this purpose, the device can have a receiving space for receiving at least one bundle of layers which are joined together to form a cell stack. Furthermore, at least one heat source is provided which can electromagnetically or electrically induce heat in the electrically conductive layers of the bundle. Depending on the design of the device, a pressing device with a lower tool and an upper tool can be used to exert a pressing force on the layers. A control unit can be used to control and regulate the generation of heat and the provision of a pressing force by the pressing device, for example based on measurement data from sensors.

According to a further aspect of the invention, an electrochemical storage device is provided. The electrochemical storage device has at least one cell housing and can, for example, be designed as a battery cell based on lithium-ion technology. At least one cell stack, which is produced according to the method according to the invention, is arranged in the cell housing. The cell stack produced by the method according to the invention is not limited to lithium-ion technology and can accordingly be used in a large number of different electrochemical cells, which require a one-piece cell stack with many layers.

By releasing heat internally to thermally activate the adhesive, the heating time until the adhesive develops its adhesive properties can be reduced. In addition, by inducing the heat into the electrically conductive layers, a more homogeneous temperature profile can be realized along a lateral direction or within the layers as well as along a thickness of the cell stack. Due to the homogeneous temperature curve in the cell stack, the outer layers are not thermally stressed or are stressed minimally more than the inner layers. The detrimental change in the material properties of the layers of the cell stack can thus be prevented.

The thermally activatable adhesive can be designed as a hot-melt adhesive, for example based on polyurethane, which is cured below a temperature threshold and is tacky or adhesive above the temperature threshold. Alternatively, a two-component adhesive with a thermally activatable curing agent can be used as a thermally activatable adhesive. The curing agent is liquefied with increasing temperature and can then react with the resin. For example, the thermally activatable adhesive can be designed as PVDF (polyvinylidene fluoride).

The electrically conductive layers of the cell stack can be heated particularly efficiently if at least one magnetic coil is arranged adjacent to the anode electrodes and/or cathode electrodes. The magnetic coil is controlled to generate a time-varying magnetic field, which inductively heats the anode electrodes and/or the cathode electrodes. In particular, the components of the anode electrodes and/or the cathode electrodes that have a high electrical conductivity are heated. For example, such components can be the copper foils and aluminum foils.

The use of several magnetic coils can be advantageous, depending on the dimensions of the cell stack, in order to generate a uniform induction of eddy currents in the electrically conductive layers. The anode electrodes and/or the cathode electrodes usually have aluminum carrier foils and copper carrier foils that are embedded or bound in corresponding anode substrates and cathode substrates. The aluminum carrier foils and copper carrier foils can be inductively heated particularly quickly and efficiently due to their high electrical conductivity.

Advantageously, the magnetic field direction of the magnetic field generated by the coil can be perpendicular to a plane of the layers or parallel to a surface normal. Thus, according to Maxwell's third equation, a resulting eddy current can be induced in the electrically conductive layers as a result of the time-varying magnetic field. However, the induced eddy currents exhibit a power loss, which has the effect of heating each individual foil of the anode electrodes and cathode electrodes. The eddy currents are preferably induced in all electrically conductive layers of the cell stack according to the magnitude of the change in the magnetic field over time.

According to a further embodiment example, the anode electrodes and/or the cathode electrodes, in particular the copper foils and aluminum foils, are electrically contacted at at least two contact positions by at least one current source and subjected to a constant or varying current in order to cause heating of the anode electrodes and/or cathode electrodes by Joule heat. By this alternative or additional measure, the electrically conductive layers can be heated by a direct application of current and a resulting generation of power loss in order to thermally activate the adhesive.

According to a further embodiment, the anode electrodes, the cathode electrodes and the separator layers are positioned in a pressing device. Advantageously, the anode electrodes, the cathode electrodes and the separator layers are pressed together by the pressing device with a constant or a time-varying force while the adhesive of the separator layers is thermally activated or after the adhesive of the separator layers has been thermally activated. A final bonding result can be ensured by applying the pressing force of the pressing device. Varying the pressing force over time can enable particularly precise control of the adhesive properties of the adhesive.

The cell stack can be heated particularly evenly if the anode electrodes and/or the cathode electrodes are inductively heated by at least two magnetic coils integrated in an upper tool and/or lower tool of the pressing device. The heating takes place, for example, by inducing eddy currents in the copper foils and aluminum foils of the respective electrodes.

According to a further embodiment example, the device has a guiding device for guiding the magnetic field generated by the magnetic coils at least in certain areas, wherein the magnetic field generated by the magnetic coils is guided via an upper section of the guiding device on the upper tool, via a lower section of the guiding device on the lower tool and via two lateral sections of the guiding device. The guiding device or the respective sections of the guiding device can, for example, form an outer section of a coil core or magnetic core, which is used to guide external magnetic field lines. The magnetic field lines generated directly by the magnetic coils can flow through the layers of the cell stack and are deflected or guided outside the cell stack via the sections of the guiding device.

The sections of the guiding device can be in electrically conductive contact or spaced apart. In addition, the sections of the guiding device can be made of a ferromagnetic metal alloy. To reduce eddy current losses in the guiding device, the sections of the guiding device can be manufactured in the form of a sheet metal package. This measure allows the magnetic return to be controlled and the operation of the magnetic coil to be particularly energy-efficient.

Depending on the design, the sections of the guiding device can be cooled by air or a liquid. Similarly, the at least one magnetic coil can be air-cooled or liquid-cooled.

The device for producing cell stacks can be designed to be particularly flexible if the magnetic field generated by the at least one magnetic coil is guided via the two lateral sections of the guiding device, which are arranged in the pressing direction between the upper section and the lower section or laterally next to the upper section and the lower section of the guiding device. Such an arrangement of the sections of the guiding device enables flexible insertion of the cell stack into the receiving space. For example, an upper tool with the upper section or a lateral section can be removed, in order to arrange a bundle of layers in the receiving space for producing a cell stack and to remove the cell stack from the receiving space after the joining process.

According to a further embodiment, a temperature is measured by a temperature measuring device during the thermal activation of the adhesive along at least one anode layer and/or cathode layer. The use of the temperature measuring device and a corresponding connection of the temperature measuring device to the control unit enables precise control of the heating in the electrically conductive layers of the cell stack. Accordingly, the at least one magnetic coil can be controlled and monitored based on the measurement data determined by the temperature measuring device.

The temperature measuring device can be implemented in a particularly versatile manner if the temperature is measured directly by at least one thermo element and/or a measuring resistor of the temperature measuring device. In an alternative embodiment, the temperature is measured indirectly by an electrical conductivity measurement of at least one anode layer and/or cathode layer by the temperature measuring device. This allows the temperature to be determined particularly precisely along the entire width or length of a layer.

### BRIEF DESCRIPTION OF THE DRAWINGS

Several embodiments of the invention are explained in more detail below with reference to the drawings. They show:

FIG. 1 is a schematic sectional view of a device for producing cell stacks to illustrate a method according to one embodiment of the invention;

FIG. 2 is a schematic sectional view of a device for producing cell stacks according to a second embodiment;

FIG. 3 a schematic sectional view of a device for producing cell stacks according to a third embodiment;

FIG. 4 is a schematic sectional view of an electrochemical storage device with a cell stack; and

FIG. 5 is a schematic detailed view of the sectional view shown in FIG. 4 to illustrate a composition of the cell stack.

### DETAILED DESCRIPTION OF THE PREFERRED EMBODIMENTS

In the illustrations, identical reference numbers indicate the same elements or structural components. The sizes and relative positions of the elements in the illustrations are not necessarily drawn to scale, and some of these elements are shown enlarged and positioned for clarity. In addition, the particular shapes of the elements drawn are not intended to convey any information about the actual shape of the individual elements, but have been selected solely for ease of recognition in the illustrations.

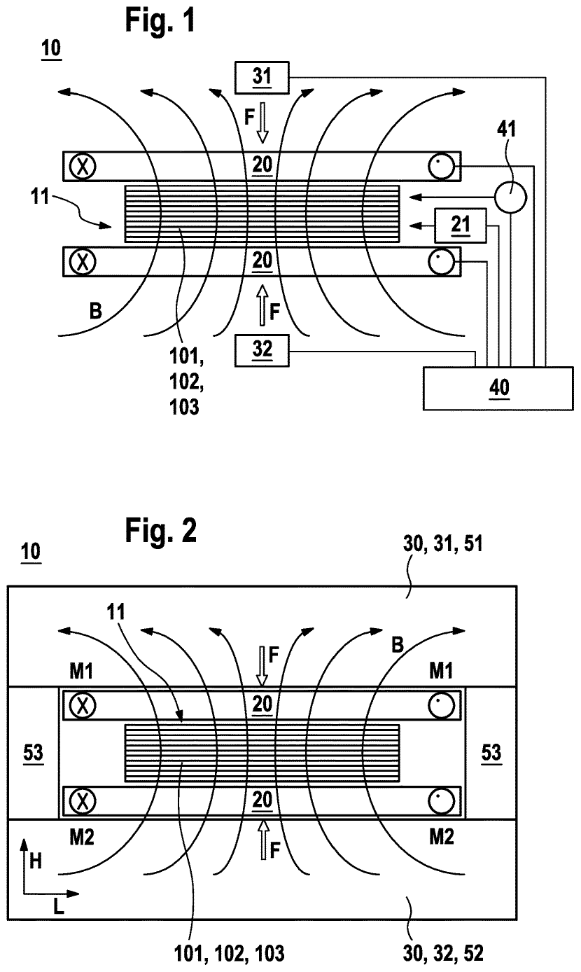

FIG. 1 shows a schematic sectional view of a device 10 for producing cell stacks 100 to illustrate a method according to one embodiment of the invention. The device 10 is shown according to a first embodiment.

The cell stack 100 to be produced by the method is intended in particular for an electrochemical storage device 200, such as a lithium-ion cell, which is shown in FIG. 4. In the embodiment shown, such a cell stack 100 comprises a plurality of anode electrodes 101, separator layers 103 and cathode electrodes 102, which are repeatedly stacked or folded or wound on top of one another.

To form an integral or one-piece cell stack 100, adhesive layers not shown are used or certain layers are provided with an adhesive in advance. For example, the separator layers 103 are coated on one or both sides with a thermally activatable adhesive or wetted with the adhesive. Depending on the configuration of the method, any layers 101, 102, 103 can be provided with the thermally activatable adhesive. The use of the adhesive in conjunction with separator layers 103 serves here to illustrate the method.

In a first step of the method, the layers 101, 102, 103 of the cell stack 100 are placed in a receiving space 11 of the device 10. The respective layers 101, 102, 103 are aligned relative to each other and can be temporarily protected against unintentional slippage by clamps, scaffolding or by the receiving space 11. The respective layers 101, 102, 103 of the cell stack 100 are shown in detail in FIG. 4 as an example.

The receiving space 11 of the device is designed to receive at least one bundle of layers 101, 102, 103 which are to be joined together to form a cell stack 100. Furthermore, at least one heat source 20, 21 is provided which can electromagnetically 20 and/or electrically 21 induce heat in the electrically conductive layers 101, 102 of the bundle. Thus, after the layers 101, 102, 103 have been provided, the electrically conductive layers 101, 102, which in the embodiment example shown are designed as anode electrodes 101 and/or cathode electrodes 102, are electromagnetically and/or electrically heated in a further step of the method.

In the illustrated embodiment example, the device 10 has a pressing device 30 with a lower tool 31 and an upper tool 32 in order to exert a pressing force F on the layers 101, 102, 103. A control unit 40 is used to control and regulate the generation of heat by the heat sources 20, 21 and the provision of a pressing force by the pressing device 30, for example based on measurement data from sensors. A temperature measuring device 41 is shown schematically in order to determine the temperature of the layers 101, 102, 103 directly or indirectly. The temperature measuring device 41 can use thermal sensors and/or electrical sensors to measure the temperature of the layers 101, 102, 103. The thermal sensors can determine the temperature based on direct contact with the layers 101, 102, 103 or based on a contactless measurement, for example by recording infrared rays.

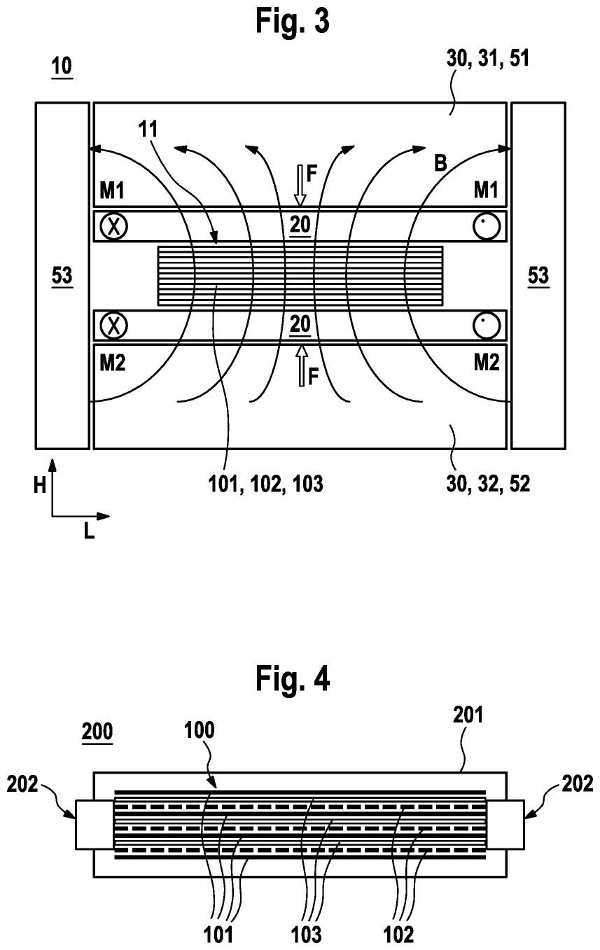

To generate uniform heating in the electrically conductive layers 101, 102, the control unit 40 can control two magnetic coils 20 to generate a time-varying magnetic field B, which inductively heats the anode electrodes 101 and/or the cathode electrodes 102. The field lines of the resulting magnetic field B are illustrated by the arrows in FIG. 1, FIG. 2 and FIG. 3.

Alternatively or additionally, the anode electrodes 101 and/or the cathode electrodes 102 can be electrically contacted at at least two contact positions by at least one current source 21 and subjected to a constant or varying current in order to cause heating of the anode electrodes 101 and/or cathode electrodes 102 by Joule heat. The current source 21 can also be controlled by the control unit 40.

By heating the anode electrodes 101 and/or the cathode electrodes 102, the adhesive of the respective separator layers 103 is thermally activated directly or immediately. Due to the thermal activation of the adhesive, the anode electrodes 101, separator layers 103 and cathode electrodes 102 are bonded together to form a one-piece cell stack 100. This step can complete the cell stack 100. Depending on the design of the method and the requirements, additional processing steps, such as electrical connection of contact lugs, adjustment of the final dimensions, application of coatings or packaging, arrangement of positioning aids and the like, can follow or be implemented as part of the method.

FIG. 2 shows a schematic sectional view of a device 10 for producing cell stacks 100 according to a second embodiment. In contrast to the embodiment example shown in FIG. 1, a device 10 is shown here which has a guiding device 50 for guiding the magnetic field B generated by the magnetic coils 20 at least in certain areas. For this purpose, the guiding device 50 has an upper section 51, a lower section 52 and two lateral sections 53.

The upper section 51 is integrated into the upper tool 31 of the pressing device 30. The lower section 52 is incorporated in the lower tool 32 of the pressing device 30. The lateral sections 53 of the guiding device 50 are positioned laterally next to the upper section 51 and the lower section 52 and form a substantially closed loop for the magnetic return flow. In the illustrated embodiment example, the receiving space 11 is located centrally within this loop.

In the illustrated embodiment example, the lateral sections 53 are positioned along a thickness or in the height direction H between the upper section 51 and the lower section 52. The height direction H corresponds to the contact pressure direction in the illustrated embodiment example.

FIG. 3 shows a schematic sectional view of a device 10 for producing cell stacks 100 according to a third embodiment. In contrast to the device 10 shown in FIG. 2, the lateral sections 53 of the guiding device 50 are offset laterally along a lateral direction L relative to the upper section 51 and the lower section 52. As a result, the upper tool 31 and the lower tool 32 can be moved freely along the height direction H relative to the lateral sections 32.

For the sake of clarity, the control unit 40 and the temperature measuring device 41 are not shown in FIG. 2 and FIG. 3.

FIG. 4 shows a schematic sectional view of an electrochemical storage device 200 with a one-piece cell stack 100. The electrochemical storage device 200 has a cell housing 201 and can, for example, be designed as a battery cell based on lithium-ion technology. At least one one-piece cell stack 100, which is manufactured according to the method of the invention, is arranged in the cell housing 201. The cell stack 100 is, for example, electrically contacted on two opposite sides by poles 202, 203.

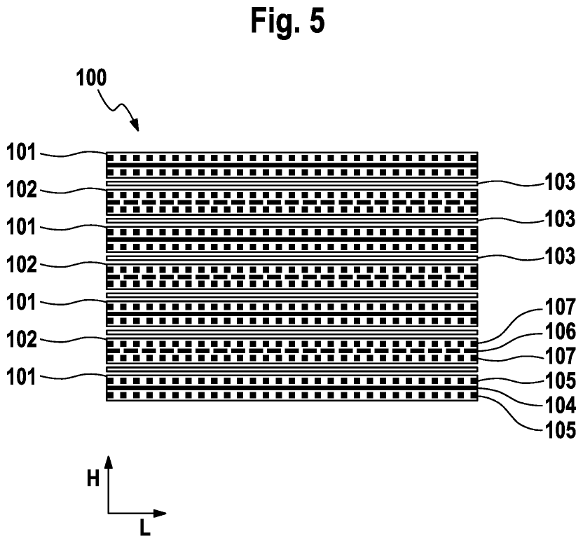

In FIG. 5, a schematic detailed view of the sectional view shown in FIG. 4 is shown to illustrate a composition of a cell stack 100. The cell stack 100 has a plurality of anode electrodes 101, separator layers 103 and cathode electrodes 102, which are repeatedly stacked or folded or wound on top of each other and have been connected to each other by the method already described.

In the illustrated embodiment example, each anode electrode 101 has a copper foil 104 or copper carrier foil, which is coated on both sides with an anode substrate 105.

Similarly, each cathode electrode 102 has an aluminum foil 106 or aluminum carrier foil, which is coated on both sides with a cathode substrate 107.

The cell stack 100 is terminated on both sides along the height direction H by anode electrodes 101, wherein the anode electrodes 101, separator layers 103 and cathode electrodes 102 alternate successively along the height direction.

1.-11. (canceled)

12. A method for producing a cell stack in particular for an electrochemical storage device, wherein at least anode electrodes, separator layers and cathode electrodes are repeatedly stacked or folded or wound on top of one another, wherein at least one layer is coated on one side or on both sides with a thermally activatable adhesive or is provided with the adhesive, wherein electrically conductive layers of the anode electrodes and/or the cathode electrodes, are heated electromagnetically and/or electrically, wherein the adhesive is thermally activated by the heating of the electrically conductive layers and the anode electrodes, separator layers and cathode electrodes are joined together to form a one-piece cell stack.

13. The method according to claim 12, wherein at least one magnetic coil is arranged adjacent to the anode electrodes and/or cathode electrodes, wherein the magnetic coil is driven to generate a time-varying magnetic field by which the anode electrodes and/or the cathode electrodes are inductively heated.

14. The method according to claim 13, wherein the anode electrodes and/or the cathode electrodes are electrically contacted at at least two contact positions by at least one current source and are subjected to a constant or varying current in order to cause heating of the anode electrodes and/or cathode electrodes by Joule heat.

15. The method according to claim 14, wherein the anode electrodes, the cathode electrodes and the separator layers are positioned in a pressing device, wherein the anode electrodes, the cathode electrodes and the separator layers are pressed together by the pressing device with a constant or a time-varying pressing force while the adhesive is thermally activated or after the adhesive has been thermally activated.

16. The method according to claim 15, wherein the anode electrodes and/or the cathode electrodes are inductively heated by at least one magnetic coil integrated in an upper tool and/or lower tool of the pressing device.

17. The method according to claim 16, wherein a guiding device is provided for guiding the magnetic field generated by the magnetic coil at least in certain regions, wherein the magnetic field generated by the magnetic coil is guided via an upper section of the guiding device on the upper tool, via a lower section of the guiding device on the lower tool and via two lateral sections of the guiding device.

18. The method according to claim 17, wherein the magnetic field generated by the at least one magnetic coil is guided via the two lateral sections of the guiding device, which are arranged in the pressing force direction between the upper section and the lower section or laterally next to the upper section and the lower section of the guiding device.

19. The method according to claim 18, wherein during the thermal activation of the adhesive along at least one anode layer and/or cathode layer a temperature is measured by a temperature measuring device.

20. The method according to claim 19, wherein the temperature is measured directly by at least one thermo element and/or a measuring resistor of the temperature measuring device;
or the temperature is measured indirectly by an electrical conductivity measurement of at least one anode layer and/or cathode layer by the temperature measuring device.

21. The method according to claim 12, wherein the anode electrodes and/or the cathode electrodes are electrically contacted at at least two contact positions by at least one current source and are subjected to a constant or varying current in order to cause heating of the anode electrodes and/or cathode electrodes by Joule heat.

22. The method according to claim 12, wherein the anode electrodes, the cathode electrodes and the separator layers are positioned in a pressing device, wherein the anode electrodes, the cathode electrodes and the separator layers are pressed together by the pressing device with a constant or a time-varying pressing force while the adhesive is thermally activated or after the adhesive has been thermally activated.

23. The method according to claim 13, wherein the anode electrodes and/or the cathode electrodes are inductively heated by at least one magnetic coil integrated in an upper tool and/or lower tool of the pressing device.

24. The method according to claim 23, wherein a guiding device is provided for guiding the magnetic field generated by the magnetic coil at least in certain regions, wherein the magnetic field generated by the magnetic coil is guided via an upper section of the guiding device on the upper tool, via a lower section of the guiding device on the lower tool and via two lateral sections of the guiding device.

25. The method according to claim 24, wherein the magnetic field generated by the at least one magnetic coil is guided via the two lateral sections of the guiding device, which are arranged in the pressing force direction between the upper section and the lower section or laterally next to the upper section and the lower section of the guiding device.

26. The method according to claim 12, wherein during the thermal activation of the adhesive along at least one anode layer and/or cathode layer a temperature is measured by a temperature measuring device.

27. The method according to claim 12, wherein the temperature is measured directly by at least one thermo element and/or a measuring resistor of the temperature measuring device;
or the temperature is measured indirectly by an electrical conductivity measurement of at least one anode layer and/or cathode layer by the temperature measuring device.

28. A device for producing cell stacks, wherein the device is adapted to perform a method according to claim 12.

29. An electrochemical storage device, comprising at least one cell housing, wherein at least one cell stack is arranged in the cell housing, which is produced according to the method according to claim 12.
